(19) United States
(12) Patent Application Publication
(10) Pub. No.: US 2026/0238429 A1
(43) Pub. Date: Aug. 13, 2026

(54) SENSING REFERENCE SIGNAL SENDING METHOD AND APPARATUS, SENSING REFERENCE SIGNAL RECEIVING METHOD AND APPARATUS, DEVICE, NETWORK, AND MEDIUM

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 19/474,928

(22) PCT Filed: Apr. 13, 2023
(86) PCT No.: PCT/CN2023/088234

§ 371 Date: Oct. 13, 2025

(51) Int. Cl. H04L 5/00

(52) U.S. Cl. CPC H04L 5/0048

(57) ABSTRACT

A method for sending a sensing reference signal, including: determining a first position set and a second position set according to a parameter configured to determine sub-carrier positions, where the first position set and the second position set are configured to indicate the sub-carrier positions; obtaining a sub-carrier position set according to the first position set and the second position set; and sending sensing reference signals according to sub-carrier positions indicated by the sub-carrier position set.

### CROSS-REFERENCE TO RELATED APPLICATION

The present application is a U.S. National Stage of International Application No. PCT/CN2023/088234, filed on Apr. 13, 2023, the contents of all of which are incorporated herein by reference in their entirety for all purposes.

### BACKGROUND OF THE INVENTION

In wireless sensing, a distance, an azimuth angle, and a velocity of a sensing target generally need to be estimated according to a sensing reference signal.

### SUMMARY OF THE INVENTION

The present disclosure relates to the technical field of communications, and in particular, to a method and device for sending a sensing reference signal, a method and device for receiving a sensing reference signal, a device, a network, and a medium.

According to a first aspect of the embodiments of the present disclosure, a method for sending a sensing reference signal is provided. The method is performed by a sensing transmitter in a sensing network and includes: determining, according to a parameter configured to determine sub-carrier positions, a first position set and a second position set, where the first position set and the second position set are configured to indicate the sub-carrier positions; obtaining, according to the first position set and the second position set, a sub-carrier position set; and sending, according to the sub-carrier positions indicated by the sub-carrier position set, sensing reference signals.

According to a second aspect of the embodiments of the present disclosure, a method for receiving a sensing reference signal is provided. The method is performed by a sensing receiver in a sensing network and includes: determining, according to a parameter configured to determine sub-carrier positions, a first position set and a second position set, where the first position set and the second position set are configured to indicate the sub-carrier positions; obtaining, according to the first position set and the second position set, a sub-carrier position set; and receiving, according to the sub-carrier positions indicated by the sub-carrier position set, sensing reference signals.

According to a third aspect of the embodiments of the present disclosure, a device for sending a sensing reference signal is provided. The device includes: a first processing module configured to determine, according to a parameter configured to determine sub-carrier positions, a first position set and a second position set, where the first position set and the second position set are configured to indicate the sub-carrier positions; a second processing module configured to obtain, according to the first position set and the second position set, a sub-carrier position set; and a first sending module configured to send, according to sub-carrier positions indicated by the sub-carrier position set, sensing reference signals.

According to a fourth aspect of the embodiments of the present disclosure, a device for receiving a sensing reference signal is provided. The device includes: a third processing module configured to determine, according to a parameter configured to determine sub-carrier positions, a first position set and a second position set, where the first position set and the second position set are configured to indicate the sub-carrier positions; a fourth processing module configured to obtain, according to the first position set and the second position set, a sub-carrier position set; and a first receiving module configured to receive, according to sub-carrier positions indicated by the sub-carrier position set, sensing reference signals.

According to a fifth aspect of the embodiments of the present disclosure, an electronic device is provided. The electronic device includes one or more processors and a memory configured to store processor-executable instructions. The one or more processors are collectively configured to perform the method for sending a sensing reference signal in the first aspect of the embodiments of the present disclosure.

According to a sixth aspect of the embodiments of the present disclosure, an electronic device is provided. The electronic device includes one or more processors and a memory configured to store processor-executable instructions. The one or more processor are configured to collectively perform the method for receiving a sensing reference signal in the second aspect of the embodiments of the present disclosure.

According to a seventh aspect of the embodiments of the present disclosure, a sensing network is provided. The sensing network includes: a sensing transmitter configured to perform the method for sending a sensing reference signal in the first aspect of the embodiments of the present disclosure; and a sensing receiver configured to perform the method for receiving a sensing reference signal in the second aspect of the embodiments of the present disclosure.

According to an eighth aspect of the embodiments of the present disclosure, a non-transitory computer-readable storage medium having computer program instructions stored thereon is provided. The computer program instructions, when collectively executed by one or more processors, implement the method for sending a sensing reference signal in the first aspect of the embodiments of the present disclosure, or implement the method for receiving a sensing reference signal in the second aspect of the embodiments of the present disclosure.

### BRIEF DESCRIPTION OF DRAWINGS

The above and/or additional aspects and advantages of the present disclosure will become apparent and easy to understand from the following description of the embodiments in conjunction with the drawings.

FIG. 1 is a schematic architecture diagram of a sensing network according to the embodiments.

FIG. 2 is a flowchart of a method for sending a sensing reference signal according to the embodiments.

FIG. 3 is a flowchart of a method for sending a sensing reference signal according to the embodiments.

FIG. 4 is a flowchart of a method for sending a sensing reference signal according to the embodiments.

FIG. 5 is a flowchart of a method for receiving a sensing reference signal according to the embodiments.

FIG. 6 is a flowchart of a method for receiving a sensing reference signal according to the embodiments.

FIG. 7 is a flowchart of a method for receiving a sensing reference signal according to the embodiments.

FIG. 8 is a block diagram of a device for sending a sensing reference signal according to the embodiments.

FIG. 9 is a block diagram of a device for receiving a sensing reference signal according to the embodiments.

FIG. 10 is a block diagram of a terminal according to the embodiments.

FIG. 11 is a block diagram of a base station according to the embodiments.

### DETAILED DESCRIPTION OF THE INVENTION

The embodiments of the present disclosure provide “a method for sending a sensing reference signal” and “a method for receiving a sensing reference signal”. In some embodiments, terms “method for sending a sensing reference signal” and “method for receiving a sensing reference signal” may be interchangeable with terms “signal processing method,” “sensing method”, etc.; and terms “device for sending a sensing reference signal” and “device for receiving a sensing reference signal” may be interchangeable with terms “signal processing device,” “sensing device”, etc.

The embodiments of the present disclosure are not exhaustive, but merely illustrative of partial embodiments, and do not constitute a specific limitation on the protection scope of the present disclosure. In a case of no contradiction, each step in a certain embodiment may be implemented as an independent embodiment, and the steps may be combined arbitrarily. For example, a solution after removing part of the steps in a certain embodiment may also be implemented as an independent embodiment, and the sequence of the steps in a certain embodiment may be exchanged arbitrarily. Furthermore, optional implementations in a certain embodiment may be combined arbitrarily. Moreover, various embodiments may be combined arbitrarily. For example, part or all of the steps of different embodiments may be combined arbitrarily, and a certain embodiment may be combined arbitrarily with optional implementations of other embodiments.

The terms used in the embodiments of the present disclosure are intended solely for the purpose of describing specific embodiments, and are not intended to limit the present disclosure. The singular expressions “one,” “a,” “said,” “the above,” “the,” “the foregoing,” “this,” etc., used in the embodiments of the present disclosure also include plural expressions, unless otherwise expressly indicated in the context. The term “predefined” in the embodiments of the present disclosure may be understood as defined, pre-defined, stored, pre-stored, pre-negotiated, pre-configured, solidified, or pre-baked, etc.

Prefix words such as “first,” “second,” etc., in the embodiments of the present disclosure serve solely to distinguish different description objects, and do not constitute any limitation on the position, sequence, priority, quantity, or content of the described objects. For example, ordinal numbers before “fields” in a “first field” and a “second field” do not limit the position or sequence of the “fields,” in a case where a described object is the “field”. The “first” and “second” do not limit whether the “fields” modified by them are in a same message, and also do not limit the sequence of the “first field” and the “second field”. For another example, ordinal numbers before “levels” in a “first level” and a “second level” do not limit the priority between the “levels,” in a case where a described object is the “level”. For another example, a quantity of described objects is not limited by ordinal numbers, and may be one or more. A “first device” is used as an example, where a quantity of “devices” may be one or more. Furthermore, objects modified by different prefix words may be the same or different. For example, a “first device” and a “second device” may be devices of a same type or devices of different types, in a case where a described object is the “device”. For another example, “first information” and “second information” may be information of same content or information of different content, in a case where a described object is the “information”. In conclusion, the use of the prefix words, such as ordinal numbers and the like, to distinguish the described objects in the embodiments of the present disclosure does not constitute a limitation on the described objects. The statement of the described objects is seen in the description of the context in the claims or the embodiments, and does not constitute a redundant limitation due to the use of such prefix words.

In the embodiments of the present disclosure, “a plurality of” means two or more. In the embodiments of the present disclosure, the term “and/or” serves to describe an association relationship of associated objects, which represents three relationships that may exist independently. For example, “A and/or B” may represent cases: A exists alone, B exists alone, and both A and B exist. A description manner in the embodiments of the present disclosure, such as “at least one of A1, A2, . . . , An,” includes a case where any one of A1, A2, . . . , An exists alone, and also includes any combination of any plurality of A1, A2, . . . , An. Each case may exist alone. For example, a description manner of “at least one of A, B, C” includes cases of a single A, a single B, a single C, a combination of A and B, a combination of A and C, a combination of B and C, and a combination of A, B, and C.

In some embodiments, recording manners “A in a case, and B in another case,” “A in response to a case, and B in response to another case,” etc., may include, according to situations, the following technical solutions: A is performed independently of B, that is, A in some embodiments; B is performed independently of A, that is, B in some embodiments; A and B are selectively performed, that is, in some embodiments, either A or B is selected to be performed; both A and B are performed, that is, both A and B in some embodiments. It is also similar in a case where there are more branches A, B, C, etc.

In some embodiments, terms “in response to,” “in response to determining that,” “in a case where,” “while,” “when,” “if,” “provided that,” etc., are interchangeable.

In some embodiments, “including A,” “containing A,” “configured to indicate A,” or “carrying A” may be interpreted as directly carrying A, or may also be interpreted as indirectly indicating A.

In some embodiments, terms “greater than,” “greater than or equal to,” “above,” “higher than,” “not less than,” etc., are interchangeable; and terms “less than,” “less than or equal to,” “below,” “lower than,” “not greater than,” etc., are interchangeable.

In some embodiments, terms “radio,” “wireless,” “Radio Access Network (RAN),” “Access Network (AN),” “RAN-based,” etc., are interchangeable.

In some embodiments, “predetermined” and “preset” may be interpreted as pre-stipulated in a protocol, or may also be interpreted as actions being preset for devices and the like.

In some embodiments, the devices and the like may be interpreted as either physical or virtual, and their names are not limited to the names described in the embodiments. Terms “apparatus,” “equipment,” “device,” “network element,” “node,” “function,” “unit,” “entity,” “system,” “chip,” “chip system,” “main body,” etc., are interchangeable.

In some embodiments, names of information, etc., are not limited to the names described in the embodiments. Terms “information,” “message,” “signaling,” “report,” “configuration,” “indication,” “parameter,” “data,” etc., are interchangeable.

In some embodiments, terms “instruction,” “program,” etc., are interchangeable.

In some embodiments, “acquiring,” “obtaining,” “getting,” “receiving,” “transmitting (sending and/or receiving)” are interchangeable, which may be interpreted as various meanings: receiving from other entities, acquiring from protocols, obtaining through self-processing, autonomously implementing, etc.

In some embodiments, “sending,” “reporting,” “issuing,” and “transmitting (sending and/or receiving)” are interchangeable.

In some embodiments, acquisition of data, information, etc., may comply with the laws and regulations of the country where it is located.

In some embodiments, data, information, etc., may be acquired with the consent of a user.

In some embodiments, terms such as a terminal, a terminal device, a user equipment (UE), a user terminal, a mobile station (MS), a mobile terminal (MT), a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, etc., are interchangeable.

In the embodiments of the present disclosure, although operations are described in a specific sequence in the drawings, this is neither to be understood as requiring that these operations are performed in a specific sequence shown or in a serial sequence, nor as requiring that all the operations shown are performed to achieve an expected result. Multitasking and parallel processing may be advantageous in a specific environment. Furthermore, sending a plurality of pieces of information through a same message is also advantageous.

Application environments of the technical solutions provided by the embodiments of the present disclosure are described.

FIG. 1 is a schematic architecture diagram of a sensing network according to some embodiments. As shown in FIG. 1, the sensing network 100 includes a sensing transmitter 101 and a sensing receiver 102. The sensing transmitter 101 is configured to send sensing reference signals, and the sensing receiver 102 is configured to receive the sensing reference signals and measure the sensing reference signals. It is to be noted that a number of the sensing transmitter 101 and a number of the sensing receiver 102 shown in FIG. 1 are provided merely as examples, and do not constitute a limitation on the embodiments of the present disclosure. In practical situations, there may be one or more sensing transmitters 101, and there may also be one or more sensing receivers 102.

In some embodiments, the sensing transmitter 101 and the sensing receiver 102 may both be base stations. In some embodiments, the sensing transmitter 101 may be a base station, and the sensing receiver 102 may be a terminal. In some embodiments, the sensing transmitter 101 may be the terminal, and the sensing receiver 102 may be the base station. In some embodiments, the sensing transmitter 101 and the sensing receiver 102 may both be terminals.

In some embodiments, the base station may include an evolved NodeB (eNB), a next generation NodeB (gNB) in a new radio (NR) system, a base station in other future communication systems, etc., but is not limited thereto.

In some embodiments, the terminal may include at least one of a mobile phone, a wearable device, an internet-of-things device, an automobile with a communication function, a smart automobile, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, but is not limited thereto.

In wireless sensing, a distance, an azimuth angle (e.g., a horizontal angle and a vertical angle), and a velocity of a sensing target generally need to be estimated. In order to improve distance estimation accuracy, a wireless sensing network needs to have a higher time domain resolution, and the time domain resolution depends on the bandwidth. In other words, reference signals for the wireless sensing, which are sensing reference signals, need to have a larger bandwidth.

In the related art, the sensing reference signals generally use a uniform comb pattern in the frequency domain. For example, as one of applications of sensing, positioning reference signals used for positioning are uniformly distributed at intervals in the frequency domain. In a given bandwidth, the comb pattern has drawbacks in terms of reference signal overhead, power constraints, fuzzy channel impulse response (CIR), etc.

In a case where a frequency domain interval of the sensing reference signals is set too small, that is, a frequency domain density is too high, an excessive overhead of the sensing reference signals is caused, and a significant amount of valuable spectrum resources is wasted, finally leading to a reduction in spectrum efficiency. Furthermore, in a case where total sending power is constant, the too small frequency domain interval of the sensing reference signals results in excessively low power per sensing reference signal resource element (RE), i.e., energy per resource element (EPRE), inevitably reducing sensing accuracy and performance.

In a case where the frequency domain interval of the sensing reference signals is set too large, that is, the frequency domain density is too low, under-sampling causes the sensing receiver to observe a plurality of mirror images of a channel impulse response, leading to fuzzy timing and sensing errors.

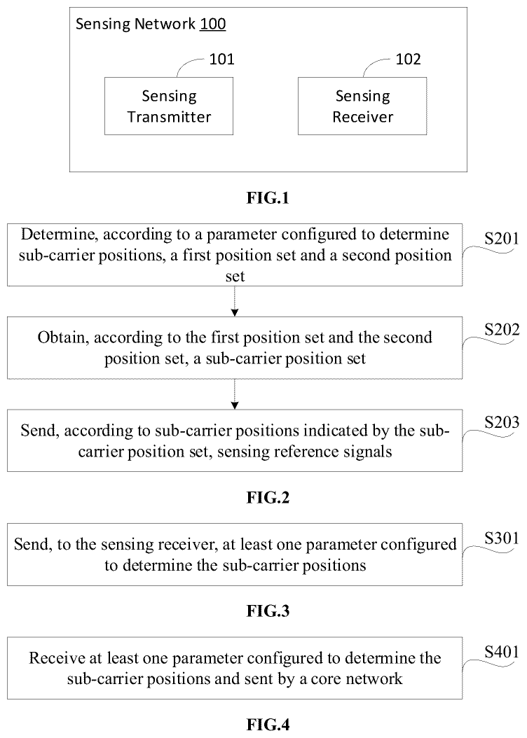

FIG. 2 is a flowchart of a method for sending a sensing reference signal according to some embodiments. As shown in FIG. 2, the method for sending a sensing reference signal may be used in a sensing transmitter of a sensing network, and includes steps S201 to S203.

In step S201, a first position set and a second position set are determined according to a parameter configured to determine sub-carrier positions.

The first position set and the second position set are configured to indicate the sub-carrier positions.

In step S202, a sub-carrier position set is obtained according to the first position set and the second position set.

In some embodiments, the sub-carrier position set may be obtained by taking a union set for the sub-carrier positions in the first position set and the second position set.

In step S203, sensing reference signals are sent according to the sub-carrier positions indicated by the sub-carrier position set.

According to the technical solutions, the sensing transmitter may first determine, according to the parameter configured to determine the sub-carrier positions, two position sets configured to indicate the sub-carrier positions, and then obtain, according to the two position sets, a final sub-carrier position set, and send, according to the sub-carrier positions indicated in the sub-carrier position set, the sensing reference signals, thereby realizing the sending of the sensing reference signals.

In some embodiments, sub-carrier positions indicated by the first position set are uniformly distributed, sub-carrier positions indicated by the second position set are uniformly distributed, and sub-carrier positions indicated by the sub-carrier position set are non-uniformly distributed.

According to the technical solutions, the sensing transmitter may first determine, according to the parameter configured to determine the sub-carrier positions, two position sets in which sub-carrier positions are uniformly distributed, and then obtain, according to the two position sets, the sub-carrier position set in which the sub-carrier positions are non-uniformly distributed, and then the sensing transmitter sends, according to the non-uniformly distributed sub-carrier positions, the sensing reference signals.

In some embodiments, a sub-carrier frequency domain interval in the first position set and a sub-carrier frequency domain interval in the second position set are determined according to a pair of coprime positive integers.

According to the technical solutions, the sensing transmitter may determine, according to the parameter configured to determine the sub-carrier positions, the two position sets in which the sub-carrier positions are uniformly distributed, and the sub-carrier frequency domain intervals in the two position sets are determined according to the pair of coprime positive integers, such that the remaining sub-carrier positions, in addition to a sub-carrier position at position 0, in the two position sets do not overlap; then, the sub-carrier position set in which the sub-carrier positions are non-uniformly distributed are obtained according to the two position sets; and the sensing transmitter sends, according to the non-uniformly distributed sub-carrier positions, the sensing reference signals.

A sensing reference signal-frequency domain pattern in which the sub-carrier positions are non-uniformly distributed in the frequency domain provided by the sub-carrier position set in the embodiments of the present disclosure, can reach a larger uniform degree of freedom in Khatri-Rao sub-space, and prevent the sensing receiver from observing the plurality of mirror images of the channel impulse response.

In some embodiments, the parameter configured to determine the sub-carrier positions includes: a minimum frequency domain interval Kmin of the sensing reference signal resource elements; a first frequency domain interval P; and a second frequency domain interval Q.

The Kmin is a positive integer, the P and the Q are a pair of coprime positive integers, and the P is less than the Q.

In some embodiments, the minimum frequency domain interval Kmin of the sensing reference signal resource elements may be predefined by a protocol.

In some embodiments, Kmin∈{2,4,6,12}.

In some embodiments, in step S201, the sensing transmitter may obtain the first position set by taking an integer from 0 to Q−1 in sequence for a variable q based on a calculation formula q*P*Kmin, and obtain the second position set by taking an integer from 1 to 2P−1 in sequence for a variable p based on a calculation formula p*Q*Kmin.

It is to be understood that each number in the first position set and the second position set, respectively, indicates one sub-carrier position in an Orthogonal Frequency Division Multiplexing (OFDM) system.

In this case, a number of the sub-carrier positions indicated by the first position set is Q, and the sub-carrier frequency domain interval is P*Kmin; and a number of the sub-carrier positions indicated by the second position set is 2P−1, and the sub-carrier frequency domain interval is Q*Kmin.

The sub-carrier position set may be represented as:

$$\{ q * P * K min \vert q = 0 , 1 , … , Q - 1 \} ⋃ \{ p * Q * K min \vert p = 1 , 2 , … , 2 P - 1 \}$$

For example, it is assumed that the Kmin is 2, P is 5, and Q is 7, then: the first position set is {0,10,20,30,40,50,60}; and the second position set is {14,28,42,56,70,84,98, 112,126}.

It can be determined that the sub-carrier position set is {0,10,14,20,28,30,40,42,50,56,60,70,84,98,112,126}.

In some other embodiments, in step S201, the sensing transmitter may obtain the first position set by taking an integer from 1 to Q−1 in sequence for a variable q based on a calculation formula q*P*Kmin, and obtain the second position set by taking an integer from 0 to 2P−1 in sequence for a variable p based on a calculation formula p*Q*Kmin.

In this case, a number of the sub-carrier positions indicated by the first position set is Q−1, and the sub-carrier frequency domain interval is P*Kmin; and a number of the sub-carrier positions indicated by the second position set is 2P, and the sub-carrier frequency domain interval is Q*Kmin.

The sub-carrier position set may be represented as:

$$\{ q * P * K min \vert q = 1 , 2 , … , Q - 1 \} ⋃ \{ p * Q * K min \vert p = 0 , 1 , 2 , … , 2 P - 1 \}$$

For example, it is assumed that the Kmin is 2, P is 5, and Q is 7, then: the first position set is {10,20,30,40,50,60}; and the second position set is {0,14,28,42,56,70,84,98,112,126}.

It can be determined that the sub-carrier position set is {0,10,14,20,28,30,40,42,50,56,60,70,84,98,112,126}.

In some other embodiments, in step S201, the sensing transmitter may obtain the first position set by taking an integer from 0 to Q−1 in sequence for a variable q based on a calculation formula q*P*Kmin, and obtain the second position set by taking an integer from 0 to 2P−1 in sequence for a variable p based on a calculation formula p*Q*Kmin.

In this case, a number of the sub-carrier positions indicated by the first position set is Q, and the sub-carrier frequency domain interval is P*Kmin; and a number of the sub-carrier positions indicated by the second position set is 2P, and the sub-carrier frequency domain interval is Q*Kmin.

The sub-carrier position set may be represented as:

$$\{ q * P * K min \vert q = 0 , 1 , 2 , … , Q - 1 \} ⋃ \{ p * Q * K min \vert p = 0 , 1 , 2 , … , 2 P - 1 \}$$

For example, it is assumed that the Kmin is 2, P is 5, and Q is 7, then: the first position set is {0,10,20,30,40,50,60}; and the second position set is {0,14,28,42,56,70,84,98,112, 126}.

It can be determined that the sub-carrier position set is {0,10,14,20,28,30,40,42,50,56,60,70,84,98,112,126}.

According to the technical solutions, the sensing reference signal-frequency domain pattern in which the sub-carrier positions are non-uniformly distributed in the frequency domain provided by the sub-carrier position set in the embodiments of the present disclosure, can reduce the resource overhead and the total sending power of the sensing reference signals, and can reach a higher time domain resolution and higher sensing accuracy.

In a case where a same time domain resolution (depending on a frequency domain bandwidth) and sensing accuracy are reached, the technical solution of the present disclosure can greatly reduce the resource overhead and the total sending power of the sensing reference signals.

For example, assuming that the sub-carrier positions indicated by the first position set are {0,10,20,30,40,50,60}, and the sub-carrier positions indicated by the second position set are {14,28,42,56,70,84,98,112,126}, the finally-obtained sub-carrier position set is {0,10,14,20,28,30,40,42,50,56,60,70,84,98,112,126}. That is, the bandwidth of the sensing reference signals of the technical solution of the present disclosure includes 127 sub-carriers, and 16 sub-carriers of the 127 sub-carriers are used.

In a case of the same time domain resolution (i.e., the same bandwidth), for a comb-pattern, it is assumed that its frequency domain interval is set to 2, 65 sub-carriers need to be used; even in a case where its frequency domain interval is set to 5, 26 sub-carriers need to be used. It can be seen that the technical solution of the present disclosure can use fewer sub-carriers, thereby reducing the resource overhead and the total sending power of the sensing reference signals.

Further, in a case of the same total sending power, the technical solution of the present disclosure can cause the resource element (RE) at which the sensing reference signals are located to have higher signal power (EPRE) and a higher signal to interference plus noise ratio (SINR), thereby achieving more accurate sensing performance.

For example, in a case where the total sending power is 10 W, following the above examples, the total sending power is distributed across 16 sub-carriers, and the power distributed across each sub-carrier is 10/16 W. For the comb-pattern, the total sending power is distributed across 65 sub-carriers (with the frequency domain interval being 2), or is distributed across 26 sub-carriers (with the frequency domain interval being 5), and the power distributed across each sub-carrier is 10/65 W (with the frequency domain interval being 2) or 10/26 W (with the frequency domain interval being 5). Thus, the technical solution of the present disclosure can cause each sensing reference signal resource element to have higher signal power (EPRE).

Further, in a case of the same resource overhead of the sensing reference signals, the technical solution of the present disclosure can obtain a wider bandwidth, thereby achieving a higher time domain resolution and more accurate sensing performance. For example, the 16 sub-carriers of the technical solution of the present disclosure may obtain the bandwidth of the 127 sub-carriers. For the comb-pattern, the same 16 sub-carriers can merely obtain the bandwidth of 31 sub-carriers (with the frequency domain interval being 2), or the bandwidth of 76 sub-carriers (with the frequency domain interval being 5). Thus, the technical solution of the present disclosure can obtain a wider bandwidth.

In some embodiments, the parameter configured to determine the sub-carrier positions includes: a minimum frequency domain interval Kmin of sensing reference signal resource elements; a first frequency domain interval P; a second frequency domain interval Q; and an offset k.

The Kmin is a positive integer, the P and the Q are a pair of coprime positive integers, the P is less than the Q, the k is a non-negative integer less than the Kmin, that is, k∈{0,1, . . . , Kmin−1}.

In some embodiments, in step S201, the sensing transmitter may obtain the first position set by taking an integer from 0 to Q−1 in sequence for a variable q based on a calculation formula q*P*Kmin+k, and obtain the second position set by taking an integer from 1 to 2P−1 in sequence for a variable p based on a calculation formula p*Q*Kmin+k.

In this case, a number of the sub-carrier positions indicated by the first position set is Q, and the sub-carrier frequency domain interval is P*Kmin; a number of the sub-carrier positions indicated by the second position set is 2P−1, and the sub-carrier frequency domain interval is Q*Kmin.

The sub-carrier position set may be represented as:

$$\{ q * P * K min + k \vert q = 0 , 1 , … , Q - 1 \} ⋃ \{ p * Q * K min + k \vert p = 1 , 2 , … , 2 P - 1 \}$$

In some other embodiments, in step S201, the sensing transmitter may obtain the first position set by taking an integer from 1 to Q−1 in sequence for a variable q based on a calculation formula q*P*Kmin+k, and obtain the second position set by taking an integer from 0 to 2P−1 in sequence for a variable p based on a calculation formula p*Q*Kmin+k.

In this case, a number of the sub-carrier positions indicated by the first position set is Q−1, and the sub-carrier frequency domain interval is P*Kmin; and a number of the sub-carrier positions indicated by the second position set is 2P, and the sub-carrier frequency domain interval is Q*Kmin.

The sub-carrier position set may be represented as:

$$\{ q * P * K min \vert q = 1 , 2 , … , Q - 1 \} ⋃ \{ p * Q * K min + k \vert p = 0 , 1 , 2 , … , 2 P - 1 \}$$

In some other embodiments, in step S201, the sensing transmitter may obtain the first position set by taking an integer from 0 to Q−1 in sequence for a variable q based on a calculation formula q*P*Kmin+k, and obtain the second position set by taking an integer from 0 to 2P−1 in sequence for a variable p based on a calculation formula p*Q*Kmin+k.

In this case, a number of the sub-carrier positions indicated by the first position set is Q, and the sub-carrier frequency domain interval is P*Kmin; and a number of the sub-carrier positions indicated by the second position set is 2P, and the sub-carrier frequency domain interval is Q*Kmin.

The sub-carrier position set may be represented as:

$$\{ q * P * K min + k \vert q = 0 , 1 , 2 , … , Q - 1 \} ⋃ \{ p * Q * K min + k \vert p = 0 , 1 , 2 , … , 2 P - 1 \}$$

It is to be understood that, based on the offset k, sub-carrier conflicts of different sensing links or sensing networks may be avoided by flexibly setting the value of the offset k.

According to the technical solutions, the sensing reference signal-frequency domain pattern in which the sub-carrier positions are non-uniformly distributed in the frequency domain provided by the sub-carrier position set in the embodiments of the present disclosure, can reduce the resource overhead and the total sending power of the sensing reference signals, and can reach a higher time domain resolution and higher sensing accuracy.

FIG. 3 is a flowchart of a method for sending a sensing reference signal according to some embodiments. As shown in FIG. 3, the method for sending a sensing reference signal may be used in the sensing transmitter of the sensing network, and includes step S301.

In step S301, at least one parameter configured to determine the sub-carrier positions is sent to the sensing receiver.

In some embodiments, the parameter configured to determine the sub-carrier positions includes: a minimum frequency domain interval Kmin of sensing reference signal resource elements; a first frequency domain interval P; and a second frequency domain interval Q.

In some embodiments, the parameter configured to determine the sub-carrier positions includes: a minimum frequency domain interval Kmin of sensing reference signal resource elements; a first frequency domain interval P; a second frequency domain interval Q; and an offset k.

In some embodiments, the sensing transmitter may generate, by itself, all parameters configured to determine the sub-carrier positions.

In some embodiments, the sensing transmitter sends, to a sensing receiver through signaling, the at least one parameter configured to determine the sub-carrier positions. For example, the sensing transmitter sends, to the sensing receiver through the signaling, at least one parameter of the minimum frequency domain interval Kmin of the sensing reference signal resource elements, the first frequency domain interval P, the second frequency domain interval Q, or the offset k.

In some embodiments, the sensing transmitter and the sensing receiver in the sensing network are both base stations, and the sensing network uses a distributed control mechanism. In some embodiments, the sensing transmitter and the sensing receiver are both gNBs.

In some embodiments, the signaling is signaling of an Xn interface or an X2 interface.

In some embodiments, one of the sensing transmitter and the sensing receiver in the sensing network is a base station, and the other one is a terminal. For example, the sensing transmitter is the base station, and the sensing receiver is the terminal. For another example, the sensing transmitter is the terminal, and the sensing receiver is the base station.

In some embodiments, the signaling is Radio Resource Control (RRC) signaling, and a signaling interface is a Uu interface. In some embodiments, the sensing transmitter and the sensing receiver in the sensing network are both terminals. In some embodiments, the signaling is the RRC signaling, and the signaling interface is a PC5 interface.

According to the technical solutions, the sensing transmitter may send, to the sensing receiver, the at least one parameter configured to determine the sub-carrier positions, such that the sensing receiver can determine, according to the parameter sent by the sensing transmitter, the sub-carrier position for receiving the sensing reference signals.

FIG. 4 is a flowchart of a method for sending a sensing reference signal according to some embodiments. As shown in FIG. 4, the method for sending a sensing reference signal may be used in the sensing transmitter of the sensing network, and includes step S401.

In step S401, at least one parameter configured to determine the sub-carrier positions and sent by a core network is received.

In some embodiments, the parameter configured to determine the sub-carrier positions includes: a minimum frequency domain interval Kmin of sensing reference signal resource elements; a first frequency domain interval P; and a second frequency domain interval Q.

In some embodiments, the parameter configured to determine the sub-carrier positions includes: a minimum frequency domain interval Kmin of sensing reference signal resource elements; a first frequency domain interval P; a second frequency domain interval Q; and an offset k.

In some embodiments, the sensing transmitter and the sensing receiver in the sensing network are both base stations, and the sensing network uses a centralized control mechanism. In some embodiments, the sensing transmitter and the sensing receiver are both gNBs.

In some embodiments, in step S401, the sensing transmitter receives the at least one parameter configured to determine the sub-carrier positions and sent by a centralized control node in the core network.

In some embodiments, the sensing transmitter and the sensing receiver in the sensing network both are connected to the centralized control node in the core network. The centralized control node generates, respectively for each sensing transmitter connected by the centralized control node, at least one parameter configured to determine the sub-carrier positions, and sends, to the corresponding sensing transmitter through signaling, the generated parameter. For example, the centralized control node sends, to the sensing transmitter through the signaling, at least one parameter of the minimum frequency domain interval Kmin of the sensing reference signal resource elements, the first frequency domain interval P, the second frequency domain interval Q, or the offset k.

In some embodiments, the signaling interface may be an interface from the centralized control node in the core network to the gNB, for example, a wired connection interface.

In some embodiments, the centralized control node in the core network may further send, to all the sensing receivers connected by the centralized control node through the signaling, the parameter configured to determine the sub-carrier positions and corresponding to each sensing transmitter connected by the centralized control node, such that each sensing receiver can know the parameters configured to determine the sub-carrier positions and corresponding to all the sensing transmitters.

According to the technical solutions, in a case where the sensing transmitter and the sensing receiver in the sensing network both are base stations and the sensing network uses the centralized control mechanism, the parameter configured to determine the sub-carrier positions may be generated and sent, by the centralized control node in the core network, to the sensing transmitter in the sensing network.

In some embodiments, in a case where the centralized control node in the core network does not send all the parameters configured to determine the sub-carrier positions, default values may be used for the parameters that are not sent by the centralized control node.

In some embodiments, in a case where the centralized control node in the core network currently does not send all the parameters configured to determine the sub-carrier positions, but for the parameters that are not sent currently, the centralized control node has previously sent the values of the parameters, the value of the parameter previously sent by the centralized control node may be used.

In some embodiments, the sensing network includes a plurality of sensing transmitters, and the plurality of sensing transmitters are all base stations, and the sensing receiver in the sensing network is a terminal.

In some embodiments, the plurality of sensing transmitters are all gNBs.

In some embodiments, in step S401, the sensing transmitter receives at least one parameter configured to determine the sub-carrier positions and sent by the core network element.

In some embodiments, the core network element generates, respectively for each sensing transmitter in the sensing network, the at least one parameter configured to determine the sub-carrier positions, and sends, to the corresponding sensing transmitter, the generated parameter. For example, the core network element sends, to the sensing transmitter through signaling, at least one parameter of the minimum frequency domain interval Kmin of the sensing reference signal resource elements, the first frequency domain interval P, the second frequency domain interval Q, or the offset k.

In some embodiments, the core network element may further send, to the sensing receiver in the sensing network through signaling, the parameters configured to determine the sub-carrier positions and corresponding to the plurality of sensing transmitters in the sensing network, such that the sensing receiver can know the parameters configured to determine the sub-carrier positions and corresponding to all the sensing transmitters involved in the sensing network at which the sensing receiver is located.

According to the technical solutions, in a case where the sensing network includes the plurality of sensing transmitters, the plurality of sensing transmitters in the sensing network are all the base stations, and the sensing receiver in the sensing network is the terminal, the parameter configured to determine the sub-carrier positions may be generated by the core network element, avoiding conflicts resulting from the parameters being respectively generated by the plurality of sensing transmitters, and the generated parameters are sent to the sensing transmitters in the sensing network.

In some embodiments, the core network element may be a location management functionality (LMF) network element, or a network element dedicated to sensing, such as a sensing management functionality (SMF) network element.

In some embodiments, in a case where the core network element does not send all the parameters configured to determine the sub-carrier positions, default values may be used for the parameters that are not sent by the core network element.

In some embodiments, in a case where the core network element currently does not send all the parameters configured to determine the sub-carrier positions, but for the parameters that are not sent currently, the core network element has previously sent the values of the parameters, the value of the parameter previously sent by the core network element may be used.

FIG. 5 is a flowchart of a method for receiving a sensing reference signal according to some embodiments. As shown in FIG. 5, the method for receiving a sensing reference signal may be used in a sensing receiver of a sensing network, and includes steps S501 to S503.

In step S501, a first position set and a second position set are determined according to a parameter configured to determine sub-carrier positions.

The first position set and the second position set are configured to indicate the sub-carrier positions.

In step S502, a sub-carrier position set is obtained according to the first position set and the second position set.

In some embodiments, the sub-carrier position set may be obtained by taking a union set for the sub-carrier positions in the first position set and the second position set.

In step S503, sensing reference signals are received according to sub-carrier positions indicated by the sub-carrier position set.

According to the technical solutions, the sensing receiver may first determine, according to the parameter configured to determine the sub-carrier positions, two position sets configured to indicate the sub-carrier positions, and then obtain, according to the two position sets, a final sub-carrier position set, and receive, according to the sub-carrier positions indicated in the sub-carrier position set, the sensing reference signals, thereby realizing the receiving of the sensing reference signals.

In some embodiments, sub-carrier positions indicated by the first position set are uniformly distributed, sub-carrier positions indicated by the second position set are uniformly distributed, and sub-carrier positions indicated by the sub-carrier position set are non-uniformly distributed.

According to the technical solutions, the sensing receiver may first determine, according to the parameter configured to determine the sub-carrier positions, two position sets in which the sub-carrier positions are uniformly distributed, and then obtain, according to the two position sets, the sub-carrier position set in which the sub-carrier positions are non-uniformly distributed, and then the sensing receiver receives, according to the non-uniformly distributed sub-carrier positions, the sensing reference signals.

In some embodiments, a sub-carrier frequency domain interval in the first position set and a sub-carrier frequency domain interval in the second position set are determined according to a pair of coprime positive integers.

According to the technical solutions, the sensing receiver may determine, according to the parameter configured to determine the sub-carrier positions, the two position sets in which the sub-carrier positions are uniformly distributed, and the sub-carrier frequency domain intervals in the two position sets are determined according to the pair of coprime positive integers, such that the remaining sub-carrier positions, in addition to a sub-carrier position at position 0, in the two position sets do not overlap; then, the sub-carrier position set in which the sub-carrier positions are non-uniformly distributed are obtained according to the two position sets, and then the sensing receiver receives, according to the non-uniformly distributed sub-carrier positions, the sensing reference signals, and measures the sensing reference signals.

A sensing reference signal-frequency domain pattern in which the sub-carrier positions are non-uniformly distributed in the frequency domain provided by the sub-carrier position set in the embodiments of the present disclosure, can reach a larger uniform degree of freedom in Khatri-Rao sub-space, and prevent the sensing receiver from observing a plurality of mirror images of the channel impulse response.

In some embodiments, the parameter configured to determine the sub-carrier positions includes: a minimum frequency domain interval Kmin of sensing reference signal resource elements; a first frequency domain interval P; and a second frequency domain interval Q.

The Kmin is a positive integer, the P and the Q are a pair of coprime positive integers, and the P is less than the Q.

In some embodiments, the minimum frequency domain interval Kmin of the sensing reference signal resource elements may be predefined by a protocol.

In some embodiments, Kmin∈{2,4,6,12}.

In some embodiments, in step S501, the sensing receiver may obtain the first position set by taking an integer from 0 to Q−1 in sequence for a variable q based on a calculation formula q*P*Kmin, and obtain the second position set by taking an integer from 1 to 2P−1 in sequence for a variable p based on a calculation formula p*Q*Kmin.

In some other embodiments, in step S501, the sensing receiver may obtain the first position set by taking an integer from 1 to Q−1 in sequence for a variable q based on a calculation formula q*P*Kmin, and obtain the second position set by taking an integer from 0 to 2P−1 in sequence for a variable p based on a calculation formula p*Q*Kmin.

In some other embodiments, in step S501, the sensing receiver may obtain the first position set by taking an integer from 0 to Q−1 in sequence for a variable q based on a calculation formula q*P*Kmin, and obtain the second position set by taking an integer from 0 to 2P−1 in sequence for a variable p based on a calculation formula p*Q*Kmin.

According to the technical solutions, the sensing reference signal-frequency domain pattern in which the sub-carrier positions are non-uniformly distributed in the frequency domain provided by the sub-carrier position set in the embodiments of the present disclosure, can reduce the resource overhead and the total sending power of the sensing reference signals, and can reach a higher time domain resolution and higher distance sensing accuracy.

In some embodiments, the parameter configured to determine the sub-carrier positions includes: a minimum frequency domain interval Kmin of sensing reference signal resource elements; a first frequency domain interval P; a second frequency domain interval Q; and an offset k.

The Kmin is a positive integer, the P and the Q are a pair of coprime positive integers, the P is less than the Q, the k is a non-negative integer less than the Kmin, that is, k∈{0,1, . . . , Kmin−1}.

In some embodiments, in step S501, the sensing receiver may obtain the first position set by taking an integer from 0 to Q−1 in sequence for a variable q based on a calculation formula q*P*Kmin+k, and obtain the second position set by taking an integer from 1 to 2P−1 in sequence for a variable p based on a calculation formula p*Q*Kmin+k.

In some other embodiments, in step S501, the sensing receiver may obtain the first position set by taking an integer from 1 to Q−1 in sequence for a variable q based on a calculation formula q*P*Kmin+k, and obtain the second position set by taking an integer from 0 to 2P−1 in sequence for a variable p based on a calculation formula p*Q*Kmin+k.

In some other embodiments, in step S501, the sensing receiver may obtain the first position set by taking an integer from 0 to Q−1 in sequence for a variable q based on a calculation formula q*P*Kmin+k, and obtain the second position set by taking an integer from 0 to 2P−1 in sequence for a variable p based on a calculation formula p*Q*Kmin+k.

It is to be understood that, based on the offset k, sub-carrier conflicts of different sensing links or sensing networks may be avoided by flexibly setting the value of the offset k.

According to the technical solutions, the sensing reference signal-frequency domain pattern in which the sub-carrier positions are non-uniformly distributed in the frequency domain provided by the sub-carrier position set in the embodiments of the present disclosure, can reduce the resource overhead and the total sending power of the sensing reference signals, and can reach a higher time domain resolution and higher sensing accuracy.

It is to be noted that the implementations and related examples that the sensing receiver determines the first position set and the second position set may be with reference to the process that the sensing transmitter determines the first position set and the second position set, and are not described herein again.

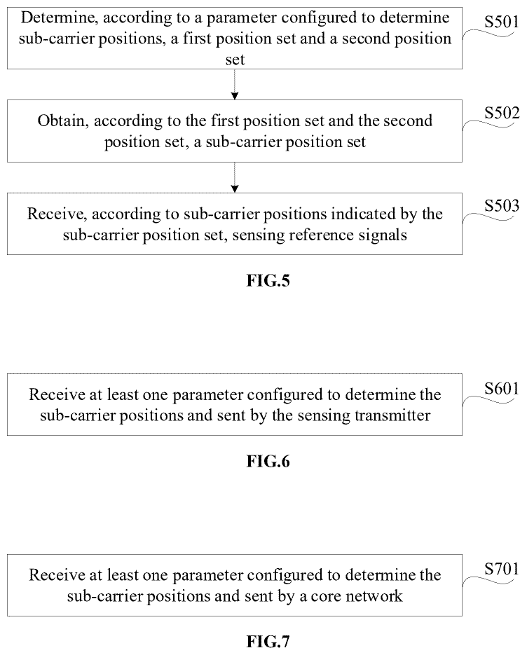

FIG. 6 is a flowchart of a method for receiving a sensing reference signal according to some embodiments. As shown in FIG. 6, the method for receiving a sensing reference signal may be used in the sensing receiver of the sensing network, and includes step S601.

In step S601, at least one parameter configured to determine the sub-carrier positions and sent by the sensing transmitter is received.

In some embodiments, the sensing transmitter sends, to the sensing receiver through signaling, the at least one parameter configured to determine the sub-carrier positions.

In some embodiments, the sensing transmitter and the sensing receiver in the sensing network are both base stations, and the sensing network uses a distributed control mechanism.

In some embodiments, the sensing transmitter and the sensing receiver are both gNBs.

In some embodiments, the signaling is signaling of an Xn interface or an X2 interface.

In some embodiments, one of the sensing transmitter and the sensing receiver in the sensing network is a base station, and the other one is a terminal. For example, the sensing transmitter is the base station, and the sensing receiver is the terminal. For another example, the sensing transmitter is the terminal, and the sensing receiver is the base station.

In some embodiments, the signaling is Radio Resource Control (RRC) signaling, and a signaling interface is a Uu interface.

In some embodiments, the sensing transmitter and the sensing receiver in the sensing network are both terminals.

In some embodiments, the signaling is the RRC signaling, and the signaling interface is a PC5 interface.

According to the technical solutions, the sensing receiver receives the at least one parameter configured to determine the sub-carrier positions and sent by the sensing transmitter, such that the sensing receiver can determine, according to the parameter sent by the sensing transmitter, the sub-carrier position for receiving the sensing reference signals.

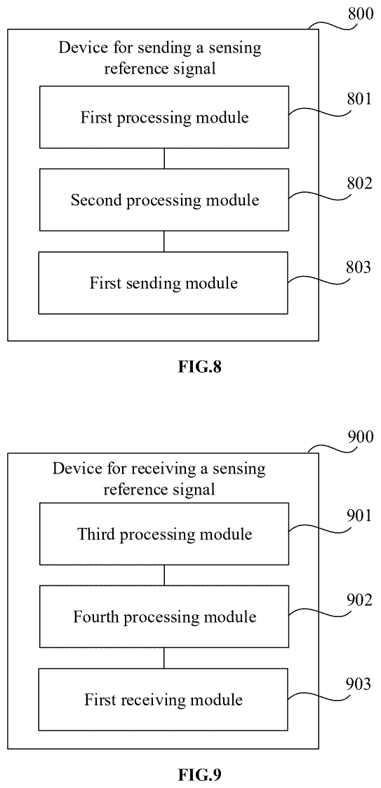

FIG. 7 is a flowchart of a method for receiving a sensing reference signal according to some embodiments. As shown in FIG. 7, the method for receiving a sensing reference signal may be used in the sensing receiver of the sensing network, and includes step S701.

In step S701, at least one parameter configured to determine the sub-carrier positions and sent by a core network is received.

In some embodiments, the sensing transmitter and the sensing receiver in the sensing network both are base stations, and the sensing network uses a centralized control mechanism.

In some embodiments, the sensing transmitter and the sensing receiver both are gNBs.

In some embodiments, in step S701, the sensing receiver receives the at least one parameter configured to determine the sub-carrier positions and sent by a centralized control node in the core network.

In some embodiments, the sensing transmitter and the sensing receiver in the sensing network both are connected to the centralized control node in the core network. The centralized control node may send, to all the sensing receivers connected by the centralized control node through signaling, the parameter configured to determine the sub-carrier positions and corresponding to each sensing transmitter connected by the centralized control node, such that each sensing receiver can know the parameters configured to determine the sub-carrier positions and corresponding to all the sensing transmitters.

According to the technical solutions, in a case where the sensing transmitter and the sensing receiver in the sensing network both are base stations and the sensing network uses the centralized control mechanism, the parameter configured to determine the sub-carrier positions may be generated and sent by the centralized control node in the core network, to the sensing receiver in the sensing network.

In some embodiments, in a case where the centralized control node in the core network does not send all the parameters configured to determine the sub-carrier positions, default values may be used for the parameters that are not sent by the centralized control node.

In some embodiments, in a case where the centralized control node in the core network currently does not send all the parameters configured to determine the sub-carrier positions, but for the parameters that are not sent currently, the centralized control node has previously sent the values of the parameters, the value of the parameter previously sent by the centralized control node may be used.

In some embodiments, the sensing network includes a plurality of sensing transmitters, and the plurality of sensing transmitters are all base stations, and the sensing receiver in the sensing network is a terminal.

In some embodiments, the plurality of sensing transmitters are all gNBs.

In some embodiments, in step S701, the sensing receiver receives at least one parameter configured to determine the sub-carrier positions and sent by the core network element.

In some embodiments, the core network element may send, to the sensing receiver in the sensing network through signaling, the parameters configured to determine the sub-carrier positions and corresponding to the plurality of sensing transmitters in the sensing network, such that the sensing receiver can know the parameters configured to determine the sub-carrier positions and corresponding to all the sensing transmitters involved in the sensing network at which the sensing receiver is located.

In some embodiments, the core network element may transparently transmit, to the sensing receiver through the base station, the parameters corresponding to the plurality of sensing transmitters.

In some embodiments, the core network element transparently transmits the parameters to the sensing receiver through non-access stratum (NAS) signaling.

According to the technical solutions, in a case where the sensing network includes the plurality of sensing transmitters, the plurality of sensing transmitters in the sensing network are all the base stations, and the sensing receiver in the sensing network is the terminal, the parameters configured to determine the sub-carrier positions and corresponding to the plurality of sensing transmitters in the sensing network may be sent to the sensing receiver in the sensing network through the core network element.

In some embodiments, the core network element may be an LMF network element or a network element dedicated to sensing, such as an SMF network element.

In some embodiments, in a case where the core network element does not send all the parameters configured to determine the sub-carrier positions, default values may be used for the parameters that are not sent by the core network element.

In some embodiments, in a case where the core network element currently does not send all the parameters configured to determine the sub-carrier positions, but for the parameters that are not sent currently, the core network element has previously sent the values of the parameters, the value of the parameter previously sent by the core network element may be used.

FIG. 8 is a block diagram of a device for sending a sensing reference signal according to some embodiments. With reference to FIG. 8, the device for sending a sensing reference signal 800 is applied to a sensing transmitter in a sensing network. The device for sending a sensing reference signal 800 may include a first processing module 801, a second processing module 802, and a first sending module 803.

The first processing module 801 is configured to determine, according to a parameter configured to determine sub-carrier positions, a first position set and a second position set, where the first position set and the second position set are configured to indicate the sub-carrier positions.

The second processing module 802 is configured to obtain, according to the first position set and the second position set, a sub-carrier position set.

The first sending module 803 is configured to send, according to sub-carrier positions indicated by the sub-carrier position set, sensing reference signals.

In some implementations, sub-carrier positions indicated by the first position set are uniformly distributed, sub-carrier positions indicated by the second position set are uniformly distributed, and sub-carrier positions indicated by the sub-carrier position set are non-uniformly distributed.

In some implementations, a sub-carrier frequency domain interval in the first position set and a sub-carrier frequency domain interval in the second position set are determined according to a pair of coprime positive integers.

In some implementations, the parameter configured to determine the sub-carrier positions includes: a minimum frequency domain interval Kmin of sensing reference signal resource elements, where the Kmin is a positive integer; a first frequency domain interval P; and a second frequency domain interval Q, where the P and the Q are a pair of coprime positive integers, and the P is less than the Q.

In some implementations, the first processing module 801 is configured to: obtain the first position set by taking an integer from 0 to Q−1 in sequence for a variable q based on a calculation formula q*P*Kmin, and obtain the second position set by taking an integer from 1 to 2P−1 in sequence for a variable p based on a calculation formula p*Q*Kmin.

In some implementations, the first processing module 801 is configured to: obtain the first position set by taking an integer from 1 to Q−1 in sequence for a variable q based on a calculation formula q*P*Kmin, and obtain the second position set by taking an integer from 0 to 2P−1 in sequence for a variable p based on a calculation formula p*Q*Kmin.

In some implementations, the first processing module 801 is configured to: obtain the first position set by taking an integer from 0 to Q−1 in sequence for a variable q based on a calculation formula q*P*Kmin, and obtain the second position set by taking an integer from 0 to 2P−1 in sequence for a variable p based on a calculation formula p*Q*Kmin.

In some implementations, the parameter configured to determine the sub-carrier positions further includes an offset k, where the k is a non-negative integer less than the Kmin.

In some implementations, the first processing module 801 is configured to: obtain the first position set by taking an integer from 0 to Q−1 in sequence for a variable q based on a calculation formula q*P*Kmin+k, and obtain the second position set by taking an integer from 1 to 2P−1 in sequence for a variable p based on a calculation formula p*Q*Kmin+k.

In some implementations, the first processing module 801 is configured to: obtain the first position set by taking an integer from 1 to Q−1 in sequence for a variable q based on a calculation formula q*P*Kmin+k, and obtain the second position set by taking an integer from 0 to 2P−1 in sequence for a variable p based on a calculation formula p*Q*Kmin+k.

In some implementations, the first processing module 801 is configured to: obtain the first position set by taking an integer from 0 to Q−1 in sequence for a variable q based on a calculation formula q*P*Kmin+k, and obtain the second position set by taking an integer from 0 to 2P−1 in sequence for a variable p based on a calculation formula p*Q*Kmin+k.

In some implementations, the sensing transmitter and the sensing receiver in the sensing network are both base stations, and the sensing network uses a distributed control mechanism. The device for sending a sensing reference signal 800 further includes a second sending module (not shown) configured to send, to the sensing receiver, at least one parameter configured to determine the sub-carrier positions.

In some implementations, the sensing transmitter and the sensing receiver in the sensing network are both base stations, and the sensing network uses a centralized control mechanism. The device for sending a sensing reference signal 800 further includes a second receiving module (not shown) configured to receive at least one parameter configured to determine the sub-carrier positions and sent by a core network.

In some implementations, one of the sensing transmitter or the sensing receiver in the sensing network is a base station, and the other one is a terminal. The device for sending a sensing reference signal 800 further includes a third sending module (not shown) configured to send, to the sensing receiver, at least one parameter configured to determine the sub-carrier positions.

In some implementations, the sensing network includes a plurality of sensing transmitters, and the plurality of sensing transmitters are all base stations, and the sensing receiver in the sensing network is a terminal. The device for sending a sensing reference signal 800 further includes a third receiving module (not shown) configured to receive at least one parameter configured to determine the sub-carrier positions and sent by a core network.

In some implementations, the sensing transmitter and the sensing receiver in the sensing network are both terminals. The device for sending a sensing reference signal 800 further includes a fourth sending module (not shown) configured to send, to the sensing receiver, at least one parameter configured to determine the sub-carrier positions.

In some implementations, the second processing module 802 is configured to obtain the sub-carrier position set by taking a union set for the sub-carrier positions in the first position set and the second position set.

FIG. 9 is a block diagram of a device for receiving a sensing reference signal according to some embodiments. With reference to FIG. 9, the device for receiving a sensing reference signal 900 is applied to a sensing receiver in a sensing network. The device for receiving a sensing reference signal 900 may include a third processing module 901, a fourth processing module 902, and a first receiving module 903.

The third processing module 901 is configured to determine, according to a parameter configured to determine sub-carrier positions, a first position set and a second position set, where the first position set and the second position set are configured to indicate the sub-carrier positions.

The fourth processing module 902 is configured to obtain, according to the first position set and the second position set, a sub-carrier position set.

The first receiving module 903 is configured to receive, according to sub-carrier positions indicated by the sub-carrier position set, sensing reference signals.

In some implementations, sub-carrier positions indicated by the first position set are uniformly distributed, sub-carrier positions indicated by the second position set are uniformly distributed, and sub-carrier positions indicated by the sub-carrier position set are non-uniformly distributed.

In some implementations, a sub-carrier frequency domain interval in the first position set and a sub-carrier frequency domain interval in the second position set are determined according to a pair of coprime positive integers.

In some implementations, the parameter configured to determine the sub-carrier positions includes: a minimum frequency domain interval Kmin of sensing reference signal resource elements, where the Kmin is a positive integer; a first frequency domain interval P; and a second frequency domain interval Q, where the P and the Q are a pair of coprime positive integers, and the P is less than the Q.

In some implementations, the third processing module 901 is configured to: obtain the first position set by taking an integer from 0 to Q−1 in sequence for a variable q based on a calculation formula q*P*Kmin, and obtain the second position set by taking an integer from 1 to 2P−1 in sequence for a variable p based on a calculation formula p*Q*Kmin.

In some implementations, the third processing module 901 is configured to: obtain the first position set by taking an integer from 1 to Q−1 in sequence for a variable q based on a calculation formula q*P*Kmin, and obtain the second position set by taking an integer from 0 to 2P−1 in sequence for a variable p based on a calculation formula p*Q*Kmin.

In some implementations, the third processing module 901 is configured to: obtain the first position set by taking an integer from 0 to Q−1 in sequence for a variable q based on a calculation formula q*P*Kmin, and obtain the second position set by taking an integer from 0 to 2P−1 in sequence for a variable p based on a calculation formula p*Q*Kmin.

In some implementations, the parameter configured to determine the sub-carrier positions further includes an offset k, where the k is a non-negative integer less than the Kmin.

In some implementations, the third processing module 901 is configured to: obtain the first position set by taking an integer from 0 to Q−1 in sequence for a variable q based on a calculation formula q*P*Kmin+k, and obtain the second position set by taking an integer from 1 to 2P−1 in sequence for a variable p based on a calculation formula p*Q*Kmin+k.

In some implementations, the third processing module 901 is configured to: obtain the first position set by taking an integer from 1 to Q−1 in sequence for a variable q based on a calculation formula q*P*Kmin+k, and obtain the second position set by taking an integer from 0 to 2P−1 in sequence for a variable p based on a calculation formula p*Q*Kmin+k.

In some implementations, the third processing module 901 is configured to: obtain the first position set by taking an integer from 0 to Q−1 in sequence for a variable q based on a calculation formula q*P*Kmin+k, and obtain the second position set by taking an integer from 0 to 2P−1 in sequence for a variable p based on a calculation formula p*Q*Kmin+k.

In some implementations, the sensing transmitter and the sensing receiver in the sensing network are both base stations, and the sensing network uses a distributed control mechanism. The device for receiving a sensing reference signal 900 further includes a fourth receiving module (not shown) configured to receive at least one parameter configured to determine the sub-carrier positions and sent by the sensing transmitter.

In some implementations, the sensing transmitter and the sensing receiver in the sensing network are both base stations, and the sensing network uses a centralized control mechanism. The device for receiving a sensing reference signal 900 further includes a fifth receiving module (not shown) configured to receive at least one parameter configured to determine the sub-carrier positions and sent by a core network.

In some implementations, one of the sensing transmitter and the sensing receiver in the sensing network is a base station, and the other one is a terminal. The device for receiving a sensing reference signal 900 further includes a sixth receiving module (not shown) configured to receive at least one parameter configured to determine the sub-carrier positions and sent by the sensing transmitter.

In some implementations, the sensing network includes a plurality of sensing transmitters, and the plurality of sensing transmitters are all base stations, and the sensing receiver in the sensing network is a terminal. The device for receiving a sensing reference signal 900 further includes a seventh receiving module (not shown) configured to receive at least one parameter configured to determine the sub-carrier positions and sent by a core network.

In some implementations, the sensing transmitter and the sensing receiver in the sensing network are both terminals. The device for receiving a sensing reference signal 900 further includes an eighth receiving module (not shown) configured to receive at least one parameter configured to determine the sub-carrier positions and sent by the sensing transmitter.

In some implementations, the fourth processing module 902 is configured to obtain the sub-carrier position set by taking a union set for the sub-carrier positions in the first position set and the second position set.

With respect to the device in the embodiments, the manner in which each module performs operations has been described in detail in the embodiments of the method, and details are not described herein again.

The present disclosure further provides a non-transitory computer-readable storage medium having computer program instructions stored thereon. The computer program instructions, when collectively executed by one or more processors, implement the method for sending a sensing reference signal provided by the present disclosure, or implement the method for receiving a sensing reference signal provided by the present disclosure.

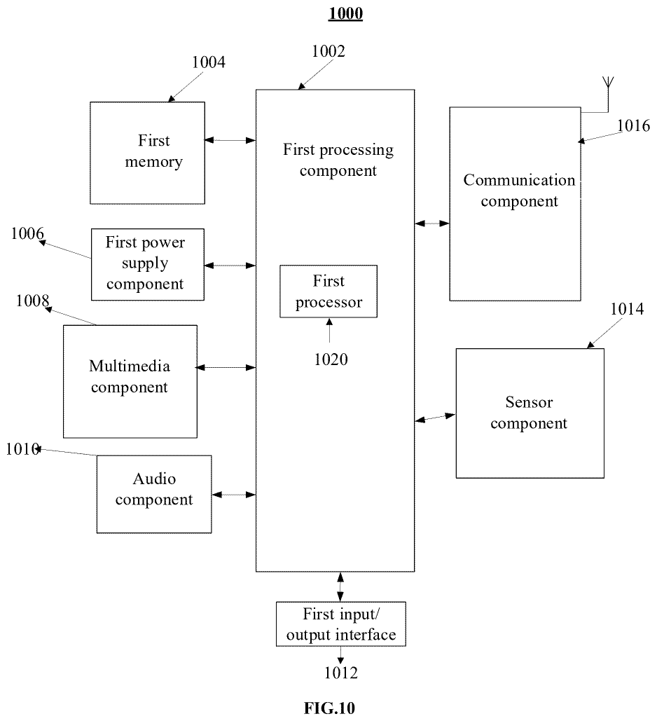

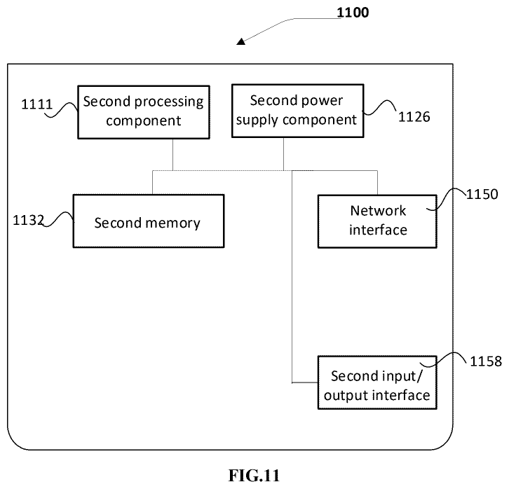

FIG. 10 is a block diagram of a terminal according to some embodiments. For example, the terminal 1000 may be a mobile phone, a computer, a digital broadcast terminal, a message transceiver device, a gaming console, a tablet device, a medical device, fitness equipment, a personal digital assistant, a smart automobile, etc. It is to be noted that the terminal 1000 may act as a sensing transmitter in a sensing network to perform the method for sending a sensing reference signal of the present disclosure, or act as a sensing receiver in the sensing network to perform the method for receiving a sensing reference signal of the present disclosure.

With reference to FIG. 10, the terminal 1000 may include one or more of the following components: a first processing component 1002, a first memory 1004, a first power supply component 1006, a multimedia component 1008, an audio component 1010, a first input/output interface 1012, a sensor component 1014, and a communication component 1016.

The first processing component 1002 generally controls an overall operation of the terminal 1000, such as the operations associated with displays, telephone calls, data communications, camera operations, and recording operations. The first processing component 1002 may include one or more first processors 1020 to execute instructions to complete all or part of the steps of the method for sending a sensing reference signal or the method for receiving a sensing reference signal as described in the present disclosure. Furthermore, the first processing component 1002 may include one or more modules facilitating interaction between the first processing component 1002 and other components. For example, the first processing component 1002 may include a multimedia module to facilitate interaction between the multimedia component 1008 and the first processing component 1002.

The first memory 1004 is configured to store various types of data to support the operations at the terminal 1000. Examples of such data include instructions for any application programs or methods operated on the terminal 1000, contact data, phonebook data, messages, pictures, video, and the like. The first memory 1004 may be implemented by any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The first power supply component 1006 provides power for various components of the terminal 1000. The first power supply component 1006 may include a power supply management system, one or more power supplies, and other components associated with the generation, management, and distribution of power for the terminal 1000.

The multimedia component 1008 includes a screen providing an output interface between the terminal 1000 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense touches, swipes, and gestures on the touch panel. The touch sensors may not only sense a boundary of a touch or swipe action but also detect a duration and pressure associated with the touch or swipe action. In some embodiments, the multimedia component 1008 includes at least one of a front camera or a rear camera. At least one of the front camera or the rear camera may receive external multimedia data, in a case where the terminal 1000 is in an operation mode, such as a shooting mode or a video mode. Each of the front camera and the rear camera may be a fixed optical lens system or have a focal length and be capable of optical zooming.

The audio component 1010 is configured to output and/or input an audio signal. For example, the audio component 1010 includes a microphone (MIC). The microphone is configured to receive an external audio signal, in a case where the terminal 1000 is in an operation mode, such as a call mode, a recording mode, and a voice recognition mode. The received audio signal may be further stored in the first memory 1004 or sent via the communication component 1016. In some embodiments, the audio component 1010 further includes a speaker configured to output the audio signal.

The first input/output interface 1012 provides an interface between the first processing component 1002 and a peripheral interface module. The peripheral interface module may be a keyboard, a click wheel, a button, or the like. Such button may include, but is not limited to, a homepage button, a volume button, a starting button, and a locking button.

The sensor component 1014 includes one or more sensors configured to provide state assessment in various aspects for the terminal 1000. For example, the sensor component 1014 may detect an on/off state of the terminal 1000 and the relative positioning of components, for example, a display and a keypad of the terminal 1000. The sensor component 1014 may further detect a change in a position of the terminal 1000 or of a component of the terminal 1000, a presence or absence of contact between the user and the terminal 1000, an orientation or acceleration/deceleration of the terminal 1000, and a change in temperature of the terminal 1000. The sensor component 1014 may include a proximity sensor configured to detect the presence of an object nearby without any physical contact. The sensor component 1014 may further include an optical sensor, such as a Complementary Metal Oxide Semiconductor (CMOS) or a Charge Coupled Device (CCD) image sensor, configured to be used in an imaging application. In some embodiments, the sensor component 1014 may further include an acceleration sensor, a gyroscope sensor, a magnetic sensor, a pressure sensor, or a temperature sensor.

The communication component 1016 is configured to facilitate wired or wireless communication between the terminal 1000 and other devices. The terminal 1000 may access a communication-standard-based wireless network, such as WiFi, 2G, 3G, 4G, 5G, 6G, or a combination thereof. In an example, the communication component 1016 receives a broadcast signal or broadcast-associated information from an external broadcast management system via a broadcast channel. In an example, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example, the terminal 1000 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements, and is configured to perform the method for sending a sensing reference signal or the method for receiving a sensing reference signal in the present disclosure.

In an example, a non-transitory computer-readable storage medium including instructions is further provided, for example, the first memory 1004 including instructions. The instructions may be executed by the first processor 1020 of the terminal 1000 to complete the method for sending a sensing reference signal or the method for receiving a sensing reference signal in the present disclosure. For example, the non-transitory computer-readable storage medium may be a ROM, a random access memory (RAM), a CD-ROM, a magnetic tape, a floppy disk, an optical data storage device, etc.

In another example, a computer program product is further provided. The computer program product includes a computer program that can be executed by a programmable device. The computer program has a code portion that is configured to implement, when executed by the programmable device, the method for sending a sensing reference signal in the present disclosure, or a code portion that is configured to implement, when executed by the programmable device, the method for receiving a sensing reference signal in the present disclosure.

FIG. 11 is a block diagram of a base station according to an example. It is to be noted that the base station 1100 may act as a sensing transmitter in a sensing network to perform the method for sending a sensing reference signal in the present disclosure, or act as a sensing receiver in the sensing network to perform the method for receiving a sensing reference signal in the present disclosure.

With reference to FIG. 11, the base station 1100 includes: a second processing component 1111 further including one or more processors; and a memory resource represented by a second memory 1132. The memory resource is configured to store instructions executable by the second processing component 1111, such as an application program. The application program stored in the second memory 1132 may include one or more modules, each of which corresponds to a set of instructions. Furthermore, the second processing component 1111 is configured to execute the instructions to perform the method for sending a sensing reference signal or the method for receiving a sensing reference signal provided by the method embodiments.

The base station 1100 may further include: a second power supply component 1126 configured to implement power management of the base station 1100; a wired or wireless network interface 1150 configured to connect the base station 1100 to a network; and a second input/output interface 1158. The base station 1100 may be operated based on an operating system stored in the second memory 1132.

As used herein, the terms “processor(s),” “processing module(s),” and the like may refer to one processor that performs the defined functions or a plurality of processors that collectively perform defined functions, such that the execution of the individual defined functions may be divided amongst such processors.

Those skilled in the art will readily conceive other implementation solutions of the present disclosure after consideration of the specification and practice of the present disclosure. The present disclosure is intended to cover any variations, uses, or adaptations of the present disclosure. These variations, uses, or adaptations follow the general principles of the disclosure and include common knowledge or customary technical means in the technical field that are not disclosed by the present disclosure. The specification and embodiments are merely regarded as illustrative, with the true scope and spirit of the present disclosure being indicated by the following claims.

It is to be understood that the present disclosure is not limited to a precise structure that has been described and shown in the drawings, and various modifications and changes can be made without departing from the scope of the present disclosure. The scope of the present disclosure is merely limited by the appended claims.

1. A method for sending a sensing reference signal, performed by a sensing transmitter in a sensing network, comprising:
determining, according to a parameter configured to determine sub-carrier positions, a first position set and a second position set, wherein the first position set and the second position set are configured to indicate the sub-carrier positions;
obtaining, according to the first position set and the second position set, a sub-carrier position set; and
sending, according to sub-carrier positions indicated by the sub-carrier position set, sensing reference signals.

2. The method according to claim 1, wherein sub-carrier positions indicated by the first position set are uniformly distributed, sub-carrier positions indicated by the second position set are uniformly distributed, and the sub-carrier positions indicated by the sub-carrier position set are non-uniformly distributed.

3. The method according to claim 2, wherein a sub-carrier frequency domain interval in the first position set and a sub-carrier frequency domain interval in the second position set are determined according to a pair of coprime positive integers.

4. The method according to claim 1, wherein the parameter configured to determine the sub-carrier positions comprises:
a minimum frequency domain interval Kmin of sensing reference signal resource elements, wherein the Kmin is a positive integer;
a first frequency domain interval P; and
a second frequency domain interval Q, and
wherein the P and the Q are a pair of coprime positive integers, and the P is less than the Q.

5. The method according to claim 4, wherein determining, according to the parameter configured to determine the sub-carrier positions, the first position set and the second position set comprises one of:
obtaining the first position set by taking an integer from 0 to Q−1 in sequence for a variable q based on a calculation formula q*P*Kmin, and obtaining the second position set by taking an integer from 1 to 2P−1 in sequence for a variable p based on a calculation formula p*Q*Kmin;
or
obtaining the first position set by taking an integer from 1 to Q−1 in sequence for a variable q based on a calculation formula q*P*Kmin, and obtaining the second position set by taking an integer from 0 to 2P−1 in sequence for a variable p based on a calculation formula p*Q*Kmin;
or
obtaining the first position set by taking an integer from 0 to Q−1 in sequence for a variable q based on a calculation formula q*P*Kmin, and obtaining the second position set by taking an integer from 0 to 2P−1 in sequence for a variable p based on a calculation formula p*Q*Kmin.

6-7. (canceled)

8. The method according to claim 4, wherein the parameter configured to determine the sub-carrier positions further comprises:
an offset k, wherein the k is a non-negative integer less than the Kmin.

9. The method according to claim 8, wherein determining, according to the parameter configured to determine the sub-carrier positions, the first position set and the second position set comprises one of:
obtaining the first position set by taking an integer from 0 to Q−1 in sequence for a variable q based on a calculation formula q*P*Kmin+k, and obtaining the second position set by taking an integer from 1 to 2P−1 in sequence for a variable p based on a calculation formula p*Q*Kmin+k;
or
obtaining the first position set by taking an integer from 1 to Q−1 in sequence for a variable q based on a calculation formula q*P*Kmin+k, and obtaining the second position set by taking an integer from 0 to 2P−1 in sequence for a variable p based on a calculation formula p*Q*Kmin+k;
or
obtaining the first position set by taking an integer from 0 to Q−1 in sequence for a variable q based on a calculation formula q*P*Kmin+k, and obtaining the second position set by taking an integer from 0 to 2P−1 in sequence for a variable p based on a calculation formula p+Q*Kmin+k.

10-11. (canceled)

12. The method according to claim 1, wherein the method further comprises at least one of:
sending, in a case where the sensing transmitter and a sensing receiver in the sensing network both are base stations, and the sensing network uses a distributed control mechanism,
to the sensing receiver at least one parameter configured to determine the sub-carrier positions;
receiving, in a case where the sensing transmitter and a sensing receiver in the sensing network both are base stations and the sensing network uses a centralized control mechanism, at least one parameter configured to determine the sub-carrier positions and sent by a core network;
sending, in a case where one of the sensing transmitter and a sensing receiver in the sensing network is a base station and the other one of the sensing transmitter and the sensing receiver in the sensing network is a terminal, to the sensing receiver at least one parameter configured to determine the sub-carrier positions;
receiving, in a case where the sensing network comprises a plurality of sensing transmitters and the plurality of sensing transmitters are all base stations and a sensing receiver in the sensing network is a terminal, at least one parameter configured to determine the sub-carrier positions and sent by a core network; or
sending, in a case where the sensing transmitter and a sensing receiver in the sensing network both are terminals, to the sensing receiver at least one parameter configured to determine the sub-carrier positions.

13-16. (canceled)

17. The method according to claim 1, wherein obtaining, according to the first position set and the second position set, the sub-carrier position set comprises:
obtaining the sub-carrier position set by taking a union set for the sub-carrier positions in the first position set and the second position set.

18. A method for receiving a sensing reference signal, performed by a sensing receiver in a sensing network, comprising:
determining, according to a parameter configured to determine sub-carrier positions, a first position set and a second position set, wherein the first position set and the second position set are configured to indicate the sub-carrier positions;
obtaining, according to the first position set and the second position set, a sub-carrier position set; and
receiving, according to sub-carrier positions indicated by the sub-carrier position set, sensing reference signals.

19. The method according to claim 18, wherein sub-carrier positions indicated by the first position set are uniformly distributed, sub-carrier positions indicated by the second position set are uniformly distributed, and the sub-carrier positions indicated by the sub-carrier position set are non-uniformly distributed.

20. The method according to claim 19, wherein a sub-carrier frequency domain interval in the first position set and a sub-carrier frequency domain interval in the second position set are determined according to a pair of coprime positive integers.

21. The method according to claim 18, wherein the parameter configured to determine the sub-carrier positions comprises:
a minimum frequency domain interval Kmin of sensing reference signal resource elements, wherein the Kmin is a positive integer;
a first frequency domain interval P; and
a second frequency domain interval Q, and
wherein the P and the Q are a pair of coprime positive integers, and the P is less than the Q.

22. The method according to claim 21, wherein determining, according to the parameter configured to determine the sub-carrier positions, the first position set and the second position set comprises one of:
obtaining the first position set by taking an integer from 0 to Q−1 in sequence for a variable q based on a calculation formula q*P*Kmin, and obtaining the second position set by taking an integer from 1 to 2P−1 in sequence for a variable p based on a calculation formula p*Q*Kmin;
or
obtaining the first position set by taking an integer from 1 to Q−1 in sequence for a variable q based on a calculation formula q*P*Kmin, and obtaining the second position set by taking an integer from 0 to 2P−1 in sequence for a variable p based on a calculation formula p*Q*Kmin;
or
obtaining the first position set by taking an integer from 0 to Q−1 in sequence for a variable q based on a calculation formula q*P*Kmin, and obtaining the second position set by taking an integer from 0 to 2P−1 in sequence for a variable p based on a calculation formula p*Q*Kmin.

23-24. (canceled)

25. The method according to claim 21, wherein the parameter configured to determine the sub-carrier positions further comprises:
an offset k, wherein the k is a non-negative integer less than the Kmin.

26. The method according to claim 25, wherein determining, according to the parameter configured to determine the sub-carrier positions, the first position set and the second position set comprises one of:
obtaining the first position set by taking an integer from 0 to Q−1 in sequence for a variable q based on a calculation formula q*P*Kmin+k, and obtaining the second position set by taking an integer from 1 to 2P−1 in sequence for a variable p based on a calculation formula p*Q*Kmin+k;
or
obtaining the first position set by taking an integer from 1 to Q−1 in sequence for a variable q based on a calculation formula q*P*Kmin+k, and obtaining the second position set by taking an integer from 0 to 2P−1 in sequence for a variable p based on a calculation formula p+Q*Kmin+k;
or
obtaining the first position set by taking an integer from 0 to Q−1 in sequence for a variable q based on a calculation formula q*P*Kmin+k, and obtaining the second position set by taking an integer from 0 to 2P−1 in sequence for a variable p based on a calculation formula p*Q*Kmin+k.

27-28. (canceled)

29. The method according to claim 18, wherein the method further comprises at least one of:
receiving, in a case where a sensing transmitter and the sensing receiver in the sensing network both are base stations, and the sensing network uses a distributed control mechanism, at least one parameter configured to determine the sub-carrier positions and sent by the sensing transmitter;
receiving, in a case where a sensing transmitter and the sensing receiver in the sensing network both are base stations and the sensing network uses a centralized control mechanism, at least one parameter configured to determine the sub-carrier positions and sent by a core network;
receiving, in a case where one of a sensing transmitter and the sensing receiver in the sensing network is a base station and the other one of the sensing transmitter and the sensing receiver in the sensing network is a terminal, at least one parameter configured to determine the sub-carrier positions and sent by the sensing transmitter;
receiving, in a case where the sensing network comprises a plurality of sensing transmitters and the plurality of sensing transmitters are all base stations and the sensing receiver in the sensing network is a terminal, at least one parameter configured to determine the sub-carrier positions and sent by a core network element; or
receiving, in a case where a sensing transmitter and the sensing receiver in the sensing network both are terminals, at least one parameter configured to determine the sub-carrier positions and sent by the sensing transmitter.

30-33. (canceled)

34. The method according to claim 18, wherein obtaining, according to the first position set and the second position set, the sub-carrier position set comprises:
obtaining the sub-carrier position set by taking a union set for the sub-carrier positions in the first position set and the second position set.

35-36. (canceled)

37. A sensing transmitter in a sensing network, comprising:
one or more processors; and
a memory configured to store processor-executable instructions, and
wherein the processor-executable instructions, when collectively executed by the one or more processors of the sensing transmitter, cause the sensing transmitter to:
determine, according to a parameter configured to determine sub-carrier positions, a first position set and a second position set, wherein the first position set and the second position set are configured to indicate the sub-carrier positions,
obtain, according to the first position set and the second position set, a sub-carrier position set, and
send, according to sub-carrier positions indicated by the sub-carrier position set, sensing reference signals.

38. A sensing receiver in a sensing network, comprising:
one or more processors; and
a memory configured to store processor-executable instructions, and
wherein the processor-executable instructions, when collectively executed by the one or more processors of the sensing receiver, cause the sensing receiver to perform the method according to of claim 18.

39-40. (canceled)
